(19) United States
(12) Patent Application Publication
(10) Pub. No.: US 2024/0387820 A1
(43) Pub. Date: Nov. 21, 2024

(54) POSITIVE ELECTRODE ACTIVE MATERIAL AND SECONDARY BATTERY

(71) Applicant: MURATA MANUFACTURING CO., LTD., Kyoto (JP)

(72) Inventors: Yukihiro KATOU, Kyoto (JP); Hitoshi NISHIMURA, Kyoto (JP); Shota FUJINAKA, Kyoto (JP); Akiko NAGAHARA, Kyoto (JP); Gerile NAREN, Kyoto (JP); Hideki NAKAI, Kyoto (JP)

(21) Appl. No.: 18/790,341

(22) Filed: Jul. 31, 2024

Related U.S. Application Data
(63) Continuation of application No. PCT/JP2023/009442, filed on Mar. 10, 2023.

(30) Foreign Application Priority Data
Mar. 15, 2022 (JP) 2022-040773

(51) Int. Cl. H01M 4/525; C01G 53/00; H01M 4/02; H01M 4/36; H01M 4/62; H01M 10/42

(52) U.S. Cl. CPC H01M 4/525; C01G 53/42; H01M 4/366; H01M 4/62; H01M 10/4235; C01P 2002/54; C01P 2002/70; C01P 2002/74; C01P 2004/80; C01P 2006/40; H01M 2004/028

(57) ABSTRACT

A positive electrode active material is provided and includes a lithium nickel composite oxide. The lithium nickel composite oxide has a composition formula represented by LiₐNiₓCo_{y}Al_{1-x-y}O₂, x is 0.8 or more and 1 or less, y is 0 or more and 0.2 or less, and a is 0.8 or more and 1.05 or less. Lithium hydroxide and lithium carbonate are contained in a supernatant of a stirred product of the positive electrode active material and pure water in a total amount of 1.0 mass % or less with respect to the positive electrode active material, when measured by a potentiometric titration method. In the positive electrode active material, an intensity ratio of a peak top in 850 eV or more and 854 eV or less to a peak top in 854 eV or more and 860 eV or less is 1.05 or more and 1.45 or less in an X-ray absorption fine structure (XAFS) spectrum for an L-absorption edge of nickel.

### CROSS REFERENCE TO RELATED APPLICATIONS

The present application is a continuation of PCT patent application no. PCT/JP2023/009442, filed on Mar. 10, 2023, which claims priority to Japanese patent application no. 2022-040773, filed on Mar. 15, 2022, the entire contents of which are herein incorporated by reference.

### BACKGROUND

The present disclosure relates to a positive electrode active material and a secondary battery.

A lithium nickel composite oxide may be used as a positive electrode active material of a lithium ion secondary battery.

### SUMMARY

The present disclosure relates to a positive electrode active material and a secondary battery.

However, when a conventional lithium nickel composite oxide is used as a positive electrode active material of a lithium ion secondary battery, lithium remaining in the lithium nickel composite oxide particles may reduce capacity retention rate, and divalent nickel may increase charge transfer resistance.

The present disclosure has been made in view of the above, and an object thereof is to provide a positive electrode active material and a secondary battery capable of suppressing an increase in charge transfer resistance in a positive electrode and a decrease in capacity retention rate.

The positive electrode active material according to an embodiment is a positive electrode active material including: a lithium nickel composite oxide, wherein the lithium nickel composite oxide has a composition formula represented by LiₐNiₓCo_{y}Al_{1-x-y}O₂, x is 0.8 or more and 1 or less, y is 0 or more and 0.2 or less, and a is 0.8 or more and 1.05 or less; lithium hydroxide and lithium carbonate are contained in a supernatant of a stirred product of the positive electrode active material and pure water in a total amount of 1.0 mass % or less with respect to the positive electrode active material, when measured by a potentiometric titration method; and in the positive electrode active material, an intensity ratio of a peak top in 850 eV or more and 854 eV or less to a peak top in 854 eV or more and 860 eV or less is 1.05 or more and 1.45 or less in an X-ray absorption fine structure (XAFS) spectrum for an L-absorption edge of nickel.

The secondary battery according to an embodiment is a secondary battery including: a positive electrode; and a negative electrode, wherein the positive electrode contains a positive electrode material containing a lithium nickel composite oxide as a positive electrode active material; the lithium nickel composite oxide has a composition formula represented by LiₐNiₓCo_{y}Al_{1-x-y}O₂, x is 0.8 or more and 1 or less, y is 0 or more and 0.2 or less, and a is 0.8 or more and 1.05 or less; lithium hydroxide and lithium carbonate are contained in a supernatant of a stirred product of the positive electrode material in state of charge (SoC) of 0% and pure water in a total amount of 1.0 mass % or less with respect to the positive electrode active material, when measured by a potentiometric titration method; and in the positive electrode in SoC of 0%, an intensity ratio of a peak top in 850 eV or more and 854 eV or less to a peak top in 854 eV or more and 860 eV or less is 1.05 or more and 1.45 or less in an X-ray absorption fine structure (XAFS) spectrum for an L-absorption edge of nickel.

According to the present disclosure, it is possible to suppress an increase in charge transfer resistance in a positive electrode and a decrease in capacity retention rate in an embodiment.

### BRIEF DESCRIPTION OF THE FIGURES

FIG. 1 is a view illustrating an example of a secondary battery according to an embodiment.

FIG. 2 is a schematic sectional view along the line II-II in FIG. 1.

FIG. 3 is an enlarged view of the region A in FIG. 2.

FIG. 4 is a cutaway view illustrating another example of a secondary battery according to an embodiment.

FIG. 5 is a schematic sectional view along the line V-V in FIG. 4.

FIG. 6 is a flowchart showing a method for synthesizing a positive electrode active material according to an embodiment.

FIG. 7 is a chart showing results of XAFS measurement according to Example 1.

FIG. 8 is a chart showing the capacity retention rate of the coin cell according to Example 1.

FIG. 9 is a Nyquist diagram of the coin cell according to Example 1 before a charge-discharge cycle test.

FIG. 10 is a Nyquist diagram of the coin cell according to Example 1 after a charge-discharge cycle test.

FIG. 11 is a chart showing results of XAFS measurement according to Comparative Example 1.

FIG. 12 is a chart showing the capacity retention rate of the coin cell according to Comparative Example 1.

FIG. 13 is a Nyquist diagram of the coin cell according to Comparative Example 1 before a charge-discharge cycle test.

FIG. 14 is a Nyquist diagram of the coin cell according to Comparative Example 1 after a charge-discharge cycle test.

FIG. 15 is a chart showing results of XAFS measurement according to Comparative Example 2.

FIG. 16 is a chart showing the capacity retention rate of the coin cell according to Comparative Example 2.

FIG. 17 is a Nyquist diagram of the coin cell according to Comparative Example 2 before a charge-discharge cycle test.

FIG. 18 is a Nyquist diagram of the coin cell according to Comparative Example 2 after a charge-discharge cycle test.

FIG. 19 is a chart showing results of XAFS measurement according to Example 2.

FIG. 20 is a chart showing the capacity retention rate of the coin cell according to Example 2.

FIG. 21 is a Nyquist diagram of the coin cell according to Example 2 before a charge-discharge cycle test.

FIG. 22 is a Nyquist diagram of the coin cell according to Example 2 after a charge-discharge cycle test.

FIG. 23 is a chart showing results of XAFS measurement according to Example 3.

FIG. 24 is a chart showing the capacity retention rate of the coin cell according to Example 3.

FIG. 25 is a Nyquist diagram of the coin cell according to Example 3 before a charge-discharge cycle test.

FIG. 26 is a Nyquist diagram of the coin cell according to Example 3 after a charge-discharge cycle test.

FIG. 27 is a graph showing the measurement results of the time course of the viscosity of positive electrode slurries using the positive electrode active materials in Examples 4 and 5 and Comparative Examples 3 and 4.

### DETAILED DESCRIPTION

The present disclosure will be described below in further detail including with reference to the figures according to an embodiment. The present disclosure is not limited thereto.

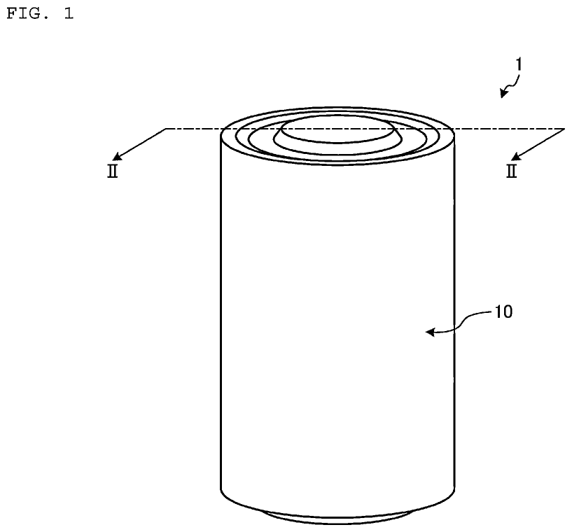

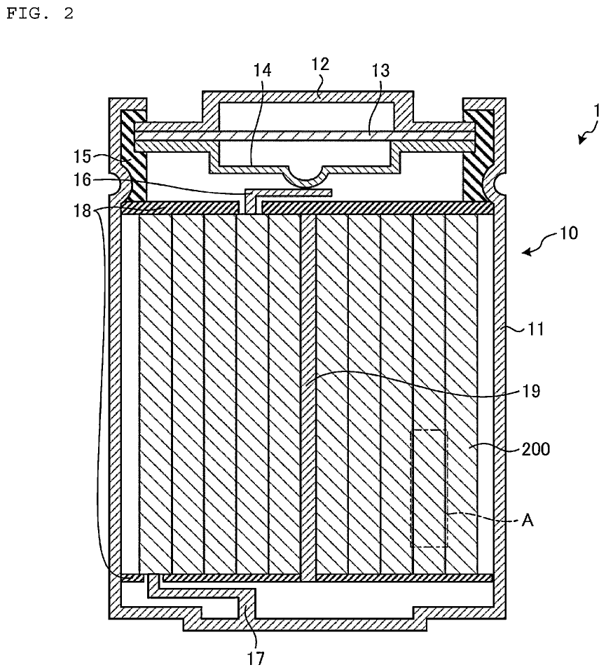

FIG. 1 is a view illustrating an example of a secondary battery according to an embodiment. FIG. 2 is a schematic sectional view along the line II-II in FIG. 1. As illustrated in FIG. 1, a secondary battery 1 is a cylindrical battery. As illustrated in FIG. 2, the secondary battery 1 includes a casing 10 and an electrode assembly 200. The casing 10 is a case that houses the electrode assembly 200 and an electrolyte solution (not shown) therein. The casing 10 includes a battery can 11, a lid 12, a heat sensitive resistance element 13, a safety valve mechanism 14, a gasket 15, a positive electrode lead 16, a negative electrode lead 17, a center pin 19, and an insulating plate 18.

The battery can 11 is a cylindrical member including an end surface serving as the negative electrode of the secondary battery 1. That is, the battery can 11 is a cylinder in which one end surface is closed and the other end surface is opened. The battery can 11 is a conductor. For example, the surface of an iron (Fe) substrate is plated with nickel (Ni).

The lid 12 is a disk-shaped member including a protrusion serving as the positive electrode of the secondary battery 1. The lid 12 is provided on the end surface on the opened side of the battery can 11. The lid 12 is made of metal. For example, the material of the lid 12 is the same material as that of the battery can 11.

Here, in the following description, the direction in which the cylindrical portion of the battery can 11 extends may be described as the length direction of the secondary battery 1. In the following description, the positive electrode of the secondary battery 1 refers to the protrusion of the lid 12, and the negative electrode of the secondary battery 1 refers to the closed end surface of the battery can 11.

The heat sensitive resistance element 13 is an element whose resistance increases due to temperature increase. The heat sensitive resistance element 13 is provided on the negative electrode side of the lid 12. When the secondary battery 1 becomes high temperature due to a short circuit or the like, the heat sensitive resistance element 13 has an increased resistance value and limits the current.

The safety valve mechanism 14 is a mechanism whose shape changes according to the gas pressure in the casing 10. The safety valve mechanism 14 is provided on the negative electrode side of the heat sensitive resistance element 13. The safety valve mechanism 14 is electrically connected to the lid 12 via the heat sensitive resistance element 13. The safety valve mechanism 14 has a protrusion on the negative electrode side, and is in contact with the positive electrode lead 16 via the protrusion for electrical connection when the gas pressure is normal in the casing 10. On the other hand, when the gas pressure is increased in the casing 10, the protrusion of the safety valve mechanism 14 is reversed to the positive electrode side to separate from the positive electrode lead 16. Thus, the positive electrode lead 16 and the lid 12 are electrically disconnected from each other.

The gasket 15 is an annular member that fixes the lid 12, the heat sensitive resistance element 13, and the safety valve mechanism 14 to the battery can 11. The gasket 15 is provided on the open end surface of the battery can 11. The gasket 15 is an insulator that brings the battery can 11 and the lid 12 into close contact with each other to make the inside of the casing 10 airtight.

The positive electrode lead 16 is a terminal connected to a positive electrode 210 of the electrode assembly 200 described later. The positive electrode lead 16 is electrically connected to the lid 12 via the safety valve mechanism 14 and the heat sensitive resistance element 13. The positive electrode lead 16 is a conductor and is made of aluminum (Al), for example.

The negative electrode lead 17 is a terminal connected to a negative electrode 220 of the electrode assembly 200 described later. The negative electrode lead 17 is electrically connected to the battery can 11. The negative electrode lead 17 is a conductor and is made of nickel (Ni), for example.

The insulating plate 18 is a plate-like member having an insulation property. Two insulating plates 18 are provided so as to cover each of the section of the electrode assembly 200 described later on the positive electrode side of the secondary battery 1 and the section of the same on the negative electrode side of the secondary battery 1.

The center pin 19 is provided along the center axis of the electrode assembly 200. The center pin 19 is a linear member having a length in the length direction of the secondary battery 1. The material of the center pin 19 is not particularly limited, and is, for example, metal.

The electrode assembly 200 includes a positive electrode 210 and a negative electrode 220, each of which is a layered member for a charge-discharge reaction of the secondary battery according to an embodiment. In the example of FIG. 2, the wound electrode assembly 200 is provided inside the battery can 11, and the center pin 19 is provided at the center of the electrode assembly 200.

FIG. 3 is an enlarged view of the region A in FIG. 2. As shown in FIG. 3, the electrode assembly 200 includes a positive electrode 210, a negative electrode 220, and a separator 230. In the secondary battery 1, the electrode assembly 200 has a structure in which the positive electrode 210 and the negative electrode 220 are laminated with the separator 230 interposed therebetween. That is, in the example of FIG. 2, the electrode assembly 200 has a structure in which the positive electrode 210, the negative electrode 220, and the separator 230 are laminated in the radial direction of the secondary battery 1 with the center pin 19 as the center.

The positive electrode 210 includes a positive electrode current collector layer 211 and a positive electrode material layer 212. In the positive electrode 210, the positive electrode current collector layer 211 is laminated between the positive electrode material layers 212. The positive electrode current collector layer 211 is a conductor, and for example, an aluminum foil or the like can be used. The positive electrode material layer 212 is a layer made of a positive electrode material. The positive electrode material contains a positive electrode active material, a conductive agent, and a binder. The conductive agent of the positive electrode material is, for example, carbon. The binder of the positive electrode material is, for example, polyvinylidene fluoride or polytetrafluoroethylene. The positive electrode active material will be described later. The positive electrode material is not limited to those described above, and may contain, for example, a dispersant.

The negative electrode 220 includes a negative electrode current collector layer 221 and a negative electrode material layer 222. In the negative electrode 220, the negative electrode current collector layer 221 is a layer laminated between the negative electrode material layers 222. The negative electrode current collector layer 221 is a conductor, and for example, a copper foil or the like can be used. The negative electrode material layer 222 is a layer made of a negative electrode material. The negative electrode material contains a negative electrode active material, but is not limited thereto, and may contain, for example, a conductive agent and a binder.

The negative electrode active material includes, for example, a material capable of occluding and releasing lithium (Li), such as a carbon material, a metal, a metalloid, an alloy or compound of silicon (Si), or an alloy or compound of tin (Sn).

Examples of the carbon material used as the negative electrode active material include graphite, non-graphitizable carbon, and graphitizable carbon.

Examples of the metal or metalloid that can be used as the negative electrode active material include tin, lead (Pb), aluminum, indium (In), silicon, zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Among them, silicon, germanium, tin, and lead are preferable. Silicon and tin are more preferable because silicon and tin have a high ability to occlude and release lithium and a high energy density can be obtained.

Examples of the alloy of silicon that can be used as the negative electrode active material include alloys containing at least one from the group consisting of tin, nickel, copper (Cu), iron (Fe), cobalt (Co), manganese (Mn), zinc, indium, silver, titanium (Ti), germanium, bismuth, antimony, and chromium (Cr) as the second constituent element other than silicon. Examples of the compound of silicon that can be used as the negative electrode active material include a compound containing oxygen (O) or carbon (C), and the compound may contain the above-described second constituent element in addition to silicon.

Examples of the alloy of tin that can be used as the negative electrode active material include alloys containing at least one from the group consisting of silicon, nickel, copper, iron, cobalt, manganese, zinc, indium, silver, titanium, germanium, bismuth, antimony, and chromium as the second constituent element other than tin. Examples of the compound of tin that can be used as the negative electrode active material include a compound containing oxygen or carbon, and the compound may contain the above-described second constituent element in addition to tin.

The separator 230 is a film that insulates the positive electrode 210 from the negative electrode 220. The separator 230 is provided so that the positive electrode 210 and the negative electrode 220 are not in direct contact with each other, and is laminated between the positive electrode 210 and the negative electrode 220 in the electrode assembly 200. The material of the separator 230 is preferably electrically stable, chemically stable against the positive electrode active material, the negative electrode active material, and the electrolytic solution, and has an insulating property. As the separator 230, for example, a layer made of a polymer nonwoven fabric, a porous film, glass, or ceramic fiber can be used. The material of the separator 230 more preferably includes a porous polyolefin film. The separator 230 may be made of a plurality of layers, and a composite of a porous polyolefin film and a heat-resistant film containing a fiber of polyimide, glass, or ceramic may be used.

An electrolyte is filled in the space surrounded by the insulating plate 18 and the battery can 11. The electrolyte includes an electrolyte salt and a solvent that dissolves the electrolyte salt. The electrolyte salt includes, for example, a lithium salt such as lithium perchlorate (LiClO₄), lithium hexafluorophosphate (LiPF₆), lithium tetrafluoroborate (LiBF₄), lithium bis (trifluoromethanesulfonyl) imide (LiN(SO₂CF₃)₂), lithium bis (pentafluoroethanesulfonyl) imide (LiN(SO₂C₂F₅)₂), or lithium hexafluoroarsenate (LiAsF₆). The solvent is, for example, a nonaqueous solvent including: a lactone-based solvent such as γ-butyrolactone, γ-valerolactone, δ-valerolactone, or ε-caprolactone; a carbonate ester-based solvent such as ethylene carbonate, propylene carbonate, butylene carbonate, vinylene carbonate, dimethyl carbonate, ethyl methyl carbonate, or diethyl carbonate; an ether-based solvent such as 1,2-dimethoxyethane, 1-ethoxy-2-methoxyethane, 1,2-diethoxyethane, tetrahydrofuran, or 2-methyltetrahydrofuran; a nitrile-based solvent such as acetonitrile; a sulfolane-based solvent; phosphoric acids; a phosphoric acid ester solvent; pyrrolidones; or the like.

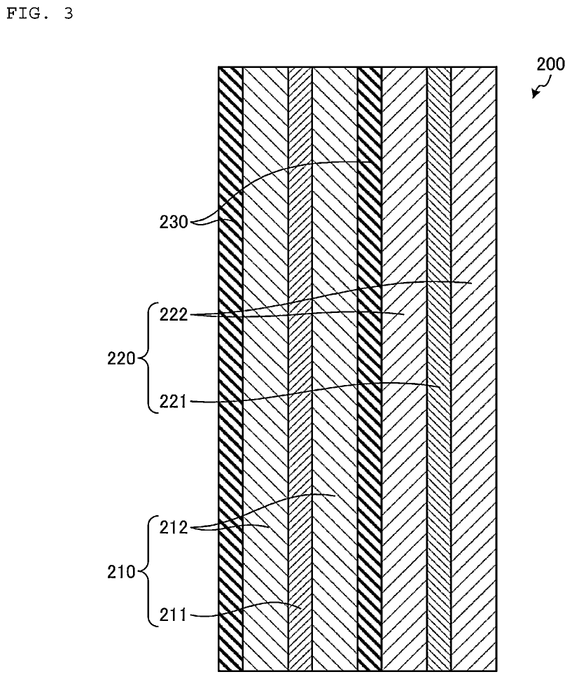

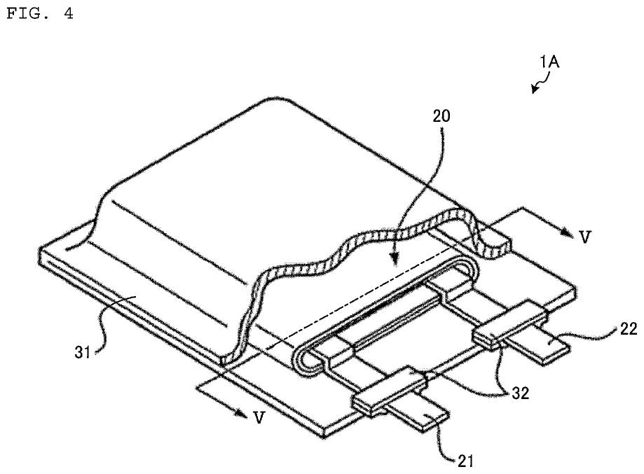

FIG. 4 is a cutaway view illustrating another example of a secondary battery according to an embodiment. The secondary battery according to an embodiment is not limited to the cylindrical secondary battery 1 illustrated in FIG. 1, and may be, for example, a secondary battery 1A illustrated in FIG. 4. Hereinafter, the secondary battery 1A according to an embodiment will be described with reference to the drawings. In the description of the secondary battery 1A, matters common to the secondary battery 1 is given the same names, and the description thereof is omitted. As shown in FIG. 4, the secondary battery 1A includes a battery element 20, an exterior member 31, and an adhesive member 32.

FIG. 5 is a schematic sectional view along the line V-V in FIG. 4. The battery element 20 is provided inside the exterior member 31. As shown in FIG. 5, the battery element 20 includes an electrode assembly 200A, a positive electrode lead 21, a negative electrode lead 22, and a protective member 23. The positive electrode lead 21 is a terminal drawn out from the inside of the battery element 20 to the outside of the exterior member 31. That is, the positive electrode lead 21 is a terminal serving as the positive electrode of the secondary battery 1A. In FIG. 5, the positive electrode lead 21 is provided near the center of the battery element 20. The negative electrode lead 22 is a terminal drawn out from the inside of the battery element 20 to the outside of the exterior member 31. That is, the negative electrode lead 22 is a terminal serving as the negative electrode of the secondary battery 1A. In FIG. 5, the negative electrode lead 22 is provided near the center of the battery element 20. The protective member 23 is a member that protects the outside of the battery element 20. The protective member 23 is provided so as to be wound around the electrode assembly 200A. The protective member 23 is, for example, an insulator tape.

The exterior member 31 is a case housing the battery element 20. The exterior member 31 includes an insulating layer, a metal layer, and an outermost layer. The exterior member 31 has a structure in which the insulating layer, the metal layer, and the outermost layer are stacked in this order from the inside, that is, from the side where the battery element 20 is provided, and the layers are bonded by lamination or the like. The insulating layer of the exterior member 31 is made of, for example, a resin such as polyethylene, polypropylene, modified polyethylene, modified polypropylene, or a polyolefin resin containing ethylene or propylene as a monomer. As a result, the exterior member 31 can lower the moisture permeability of the secondary battery 1A and improve the airtightness. The metal layer of the exterior member 31 is a metal plate or foil such as aluminum, stainless steel, nickel, or iron. The outermost layer may be an arbitrary material, but is preferably made of a material having high strength against breakage, piercing, or the like, such as a resin similar to the insulating layer or nylon.

The adhesive member 32 is a member to make the exterior member 31 airtight. The adhesive member 32 is provided between the exterior member 31, and the positive electrode lead 21 and the negative electrode lead 22. The material of the adhesive member 32 preferably has adhesion to the positive electrode lead 21 and the negative electrode lead 22. For example, when the positive electrode lead 21 and the negative electrode lead 22 are made of a metal material, a polyolefin resin such as polyethylene, polypropylene, modified polyethylene, or modified polypropylene is used as the adhesive member 32. As a result, the gap between the exterior member 31 and the positive electrode lead 21 or the negative electrode lead 22 can be sealed, so that the exterior member 31 can be made airtight.

In the example of FIG. 5, an electrode assembly 200A is a set of layers for charge-discharge reaction of the secondary battery according to an embodiment. The electrode assembly 200A includes: a positive electrode 210A including a positive electrode current collector layer 211A and a positive electrode material layer 212A; a negative electrode 220A including a negative electrode current collector layer 221A and a negative electrode material layer 222A; a separator 230A; and an electrolyte layer 240A. The electrode assembly 200A has a structure in which the electrode assembly 200A is wound around the positive electrode lead 21 and the negative electrode lead 22. The negative electrode current collector layer 221A, the negative electrode material layer 222A, the electrolyte layer 240A, the separator 230A, the electrolyte layer 240A, the positive electrode material layer 212A, the positive electrode current collector layer 211A, the positive electrode material layer 212A, the electrolyte layer 240A, the separator 230A, the electrolyte layer 240A, and the negative electrode material layer 222A are laminated in this order from the outside, that is, from the side of the protective member 23. In the electrode assembly 200A, layers other than the negative electrode current collector layer 221A, the separator 230A, and the positive electrode current collector layer 211A are not provided in the vicinity of the positive electrode lead 21 and the negative electrode lead 22. With this structure, the positive electrode current collector layer 211A is connected to the positive electrode lead 21, and the negative electrode current collector layer 221A is connected to the negative electrode lead 22.

The electrolyte layer 240A is a layer serving as the electrolyte of the secondary battery 1A. The electrolyte layer 240A is a gel-like layer made of a polymer compound that holds an electrolytic solution. The polymer compound constituting the gel of the electrolyte layer 240A can be any polymer compound as long as it absorbs a solvent to become a gel. Examples of the polymer compound constituting the gel of the electrolyte layer 240A include: a fluorine-based polymer compound such as polyvinylidene fluoride or a copolymer of vinylidene fluoride with hexafluoropropylene; an ether-based polymer compound such as polyethylene oxide or a crosslinked product containing polyethylene oxide; and a polymer compound containing polyacrylonitrile, polypropylene oxide, or polymethyl methacrylate as a monomer. The polymer compound constituting the gel of the electrolyte layer 240A is preferably a fluorine-based polymer compound from the viewpoint of stability against oxidation-reduction reaction, and more preferably a copolymer containing vinylidene fluoride and hexafluoropropylene as its components. The copolymer may further contain, as its components, a monoester of an unsaturated dibasic acid such as monomethylmaleic acid ester; ethylene halide such as ethylene trifluoride chloride; a cyclic carbonate ester of an unsaturated compound such as vinylene carbonate; an epoxy group-containing acrylic vinyl monomer; or the like. Accordingly, high cycle characteristics can be obtained.

The positive electrode active material contains a lithium nickel composite oxide (LNO). LNO is a metal oxide having a composition formula represented by LiₐNiₓCo_{y}Al_{1-x-y}O₂.

LNO has a layered rock salt type structure that belongs to the space group R-3m in which lithium (Li) occupies the 3a position and nickel (Ni), cobalt (Co), and aluminum (Al) occupy the 3b position. That is, LNO has a crystal structure in which a layer of lithium configured at the 3a position and a layer of metals configured at the 3b position are alternately laminated. In the following description, the metals configured at the 3b position may be referred to as “3b position metal”.

The “a” is 0.8 or more. Within this range, a sufficient amount of lithium as carrier ions can be secured after a solid electrolyte interphase (SEI) film is formed on the negative electrode side during initial charge to consume lithium in the positive electrode. On the other hand, the “a” is 1.05 or less. Within this range, generation of residual lithium can be suppressed in LNO.

The “x” is 0.8 or more and 1 or less, and preferably 0.87 or more and 1 or less. When nickel is contained in this composition range, the charge/discharge capacity against charge voltage can be increased. The “y” is 0 or more. When cobalt is used, LNO easily has a layered rock salt type structure that belongs to the space group R-3m during synthesis. On the other hand, the “y” is 0.2 or less, and preferably 0.11 or less. When cobalt is contained in this composition range, it is possible to suppress the use of high-priced cobalt and to provide a further inexpensive positive electrode active material.

The 3b position metal is not limited to nickel, cobalt, or aluminum. For example, titanium (Ti), zirconium (Zr), strontium (Sr), magnesium (Mg), and the like may be contained. Among the 3b position metals, the amount of substance of metals other than nickel, cobalt, or aluminum is 0% or more and 1% or less with respect to the sum of the amount of substance of the 3b position metals.

Residual lithium in LNO is 0 mass % or more and 1.0 mass % or less with respect to the positive electrode active material. Here, the residual lithium refers to lithium remaining as lithium carbonate (Li₂CO₃) or lithium hydroxide (LiOH) on the surface of the LNO particles after secondary firing. When LNO from which residual lithium has not been sufficiently removed is used as the positive electrode active material, the residual lithium reacts with components in the electrolyte to cause gelation of the positive electrode slurry, generation of resistance, and generation of gas. In addition, since residual lithium causes a side reaction with the electrolytic solution during battery operation, a non-conductive by-product is generated in the positive electrode material layer 212, and the conductive path is reduced in the positive electrode. Here, the conductive path in the positive electrode refers to an electrical path extending from the positive electrode current collector layer 211 to the outside of the positive electrode 210 in the positive electrode material layer 212 and containing conductive particles such as positive electrode active material particles. As described above, since the number of conductive paths decreases in the positive electrode, the number of positive electrode active material particles electrically connected to the positive electrode current collector layer 211 decreases, so that capacity retention rate decreases.

The mass of residual lithium is measured by neutralization titration (Warder's method) for an aqueous solution of residual lithium. Here, the aqueous solution of residual lithium refers to a supernatant obtained by stirring the positive electrode active material or the positive electrode material in state of charge (SoC) of 0% in pure water. In other words, the mass of residual lithium may refer to the total mass of lithium hydroxide and lithium carbonate contained in a supernatant of a stirred product of the positive electrode active material or the positive electrode material in SoC of 0% and pure water, that is, a supernatant obtained by stirring the positive electrode active material or the positive electrode material in SoC of 0% in pure water. Since the aqueous solution of residual lithium is an aqueous solution containing lithium hydroxide and lithium carbonate. Therefore, the amount of residual lithium can be measured from the titration amount of acid required for the neutralization point of the aqueous solution of residual lithium. In the neutralization titration, the neutralization point is identified by an electro-titration method. In the electro-titration method, the point showing the maximum change rate of the measured potential with respect to the acid-dropping amount is the final (second) neutralization point, and the point showing the second-maximum change rate of the potential is the first neutralization point. For the neutralization titration, an aqueous solution obtained by diluting the aqueous solution of residual lithium with pure water may be used.

In the neutralization titration, hydrochloric acid having a concentration of 0.1 mol/L can be used as the acid to be titrated to the aqueous solution of residual alkali. In this case, the neutralization reactions represented by the reaction formulas (1) to (3) occur, and the total mass of lithium hydroxide and lithium carbonate in the aqueous solution of residual lithium used for titration can be calculated by the formula (4). The reaction before the first neutralization point corresponds to the reaction formulas (1) and (2). The reaction from the first neutralization point to the final (second) neutralization point corresponds to the reaction formula (3). Here, in the formula (4), mii represents the total mass of lithium hydroxide and lithium carbonate in the aqueous solution of residual lithium used for titration, c represents the concentration of hydrochloric acid used for titration, f represents the factor value of hydrochloric acid used for titration (coefficient to correct the concentration of hydrochloric acid), V₁ represents the volume of hydrochloric acid required for the first neutralization point, V₂ represents the volume of hydrochloric acid required for the second neutralization point, M_{Li2CO3} represents the molecular weight of lithium carbonate, and M_{LiOH} represents the molecular weight of lithium hydroxide.

$$LiOH + HCl \to LiCl + {H}_{2} O \qquad ( 1 )$$

$${Li}_{2} {CO}_{3} + HCl \to LiCl + {LiHCO}_{3} \qquad ( 2 )$$

$${LiHCO}_{3} ++ HCl \to LiCl + {CO}_{2} + {H}_{2} O \qquad ( 3 )$$

$${m}_{L i} = cf ( {V}_{2} - {V}_{1} ) {M}_{Li 2 CO 3} + cf ( 2 {V}_{1} - {V}_{2} ) {M}_{LiOH} \qquad ( 4 )$$

Here, when residual lithium in LNO is removed so that residual lithium is 0 mass % or more and 1.0 mass % or less with respect to the positive electrode active material, a large amount of divalent nickel (Ni²⁺) is generated, and the resistance of the positive electrode active material may increase. More specifically, when residual lithium is removed from LNO by washing with water, lithium ions in the 3a configuration in the LNO crystal are replaced with hydrogen ions through the reaction represented by the following reaction formula (5). Thereafter, nickel oxide (NiO) is generated through the reaction represented by the following reaction formula (6). Nickel oxide is inactive in the charge-discharge reaction, and is known as a causative substance that increases the charge transfer resistance of the positive electrode. Therefore, the amount of divalent nickel in LNO is required to be suppressed.

LiNiO₂+H₂O→NiOOH+LiOH (5)

4NiOOH→4NiO+2H₂O+O₂ (6)

The electronic state of nickel in LNO is measured by X-ray absorption fine structure (XAFS) for the L-absorption edge of nickel (Ni L-edge). The L₃-absorption edge of nickel appears as a peak in an energy region of 850 eV or more and 860 eV or less in the XAFS spectrum of LNO.

When LNO contains divalent nickel (Ni²⁺) and trivalent nickel (Ni³⁺), the L₃-absorption edge of nickel appears as two peaks: a low-energy side peak and a high-energy side peak. The low-energy side peak is a peak appearing at 850 eV or more and 854 eV or less of the two peaks from the L₃-absorption edge of nickel. The low-energy side peak is a peak from divalent nickel (Ni²⁺). The high-energy side peak is a peak appearing at 854 eV or more and 860 eV or less. The high-energy side peak is a peak from trivalent nickel (Ni³⁺) and tetravalent nickel (Ni⁴⁺).

Here, the ratio of the intensity of the low-energy side peak to the intensity of the high-energy side peak (hereinafter, XAFS peak intensity ratio) is 1.05 or more and 1.45 or less. When the XAFS peak intensity ratio exceeds 1.45, nickel oxide is likely to be generated in the charge-discharge process, and the charge transfer resistance of the positive electrode increases. On the other hand, when the XAFS peak intensity ratio is less than 1.05, LNO is not sufficiently washed with water, so that the amount of residual lithium increases and the capacity retention rate decreases.

As the measurement sample of LNO for XAFS measurement, those obtained by applying the positive electrode active material or the positive electrode material in SoC of 0% on a carbon tape, and attaching the carbon tape on a sample plate can be used. The XAFS measurement is performed for LNO by irradiating the measurement sample in vacuum with X-rays and measuring the total amount of emitted electrons (total electron yield method). The XAFS measurement conditions may be, for example, as follows. The interval for one step in the measurement energy region may be as shown in Table 1. The measurement is performed in a state where there is no charge-up. The charge-up can be determined by the intensity in the pre-edge region (830.0 eV or more and 844.5 eV or less) and the intensity in the post-edge region (863.0 eV or more and 918.0 eV or less). When there is a charge-up, the intensity in the post-edge region decreases. In a remarkable case, the intensity in the post-edge region is lower than the intensity in the pre-edge region, and normalization of the XAFS spectrum described later is difficult.
Equipment used: Aichi SR BL1N2
Beam size: About 2 mm×1 mm
Diffraction grating frequency: 500 line/mm
Measurement energy region: 830 eV-920 eV
Measurement time per step: 2 seconds

TABLE 1

| Energy region | Step interval |
|---|---|
| (eV) | (eV) |
| 830-840 | 5 |
| 840-849 | 2 |
| 849-851 | 0.5 |
| 851-856 | 0.1 |
| 856-873 | 0.2 |
| 873-880 | 0.5 |
| 880-890 | 1 |
| 890-920 | 2 |

The obtained XAFS spectrum is calibrated. The XAFS spectrum may be calibrated based on an energy calibration value. Here, the energy calibration value can be the difference between the measurement value and the theoretical value of the photoelectron peak of the standard sample. The photoelectron peak of the standard sample can be, for example, the photoelectron peak from Au 4f_{7/2} acquired from a gold foil by X-ray photoelectron spectroscopy (XPS) or the like.

The XAFS spectrum is further subjected to background removal and normalization. The XAFS spectrum may be normalized using analysis software Athena so that the intensity of the pre-edge region on the lower energy side than the L-absorption edge of nickel (830.0 eV or more and 844.5 eV or less) is 0, and the intensity of the post-edge region on the higher energy side than the L-absorption edge of nickel (863.0 eV or more and 918.0 eV or less) is 1.

Here, the positive electrode active material contains 0 ppm or more and 350 ppm or less of water. That is, 1 kg of the positive electrode active material contains 0 mg or more and 350 mg or less of water in mass. Moisture adhering to the LNO base material causes generation of divalent nickel ions through the reaction formulas (5) and (6). In addition, hydrogen ions derived from moisture adhering to the LNO base material replace lithium in the 3a position, and cause an increase in residual lithium on the surface of LNO. Furthermore, it is known that hydroxide ions derived from moisture adhering to the LNO base material cause a defluoride reaction with a fluororesin such as polyvinylidene fluoride used as the electrolyte, so that the slurry of the positive electrode material is thickened and the slurry properties are deteriorated. Therefore, by suppressing moisture contained in the positive electrode active material to 350 ppm or less, generation of divalent nickel ions and residual lithium can be suppressed, and deterioration of the slurry properties of the positive electrode active material can be suppressed.

### (Method for Producing Positive Electrode Active Material)

FIG. 6 is a flowchart showing a method for synthesizing a positive electrode active material according to an embodiment. Hereinafter, the method for producing the positive electrode active material according to an embodiment will be described.

First, as a coprecipitation step, a composite hydroxide containing nickel is prepared by a coprecipitation method (step S10). In the composite hydroxide-preparation step, a base such as sodium hydroxide (NaOH) is added to an aqueous solution containing a nickel salt and a cobalt salt, such as nickel sulfate (NiSO₄) and cobalt sulfate (CoSO₄) to adjust to have a predetermined pH. As a result, a precipitate is generated. By stirring the pH-adjusted aqueous solution, the precipitate is particle-grown. By drying the precipitate, a secondary particulate composite hydroxide containing nickel hydroxide (Ni(OH)₂) and cobalt hydroxide (Co(OH)₂) is obtained. Here, the particle size of the mixture obtained by the coprecipitation method can be adjusted by adjusting the dropping interval of the base or the stirring time.

Next, as a precursor-preparation step, a lithium compound and a metal hydroxide other than nickel and cobalt are mixed with the composite hydroxide obtained by the coprecipitation method (step S20). As the lithium compound, for example, lithium hydroxide (LiOH), lithium carbonate (Li₂CO₃), lithium nitrate (LiNO₃), or the like can be used. The hydroxide other than nickel and cobalt is a hydroxide of a 3b-configured metal not contained in the precursor, and is, for example, aluminum hydroxide (Al(OH)₃).

The lithium compound is preferably added so that the molar ratio of lithium is 1.03 or more with respect to the amount of the 3b-configured metal in the precursor. Thereby, it is possible to suppress a case where divalent nickel or the like is configured in the 3a configuration voids, which have been generated when lithium is volatilized during firing. Therefore, it is possible to suppress a case where nickel oxide (NiO) generates electrochemically inactive sites such as rock salt domains, and to improve the electrochemical characteristics of LNO. In addition, lithium excessively added to the composition functions as a sintering aid during firing. Therefore, the crystalline growth of LNO particles can be promoted and the firing reaction can uniformly progress.

Next, as a primary firing step, the precursor is subjected to primary firing to synthesize LNO (step S30). The primary firing is performed in a high oxygen atmosphere at a firing temperature of 650° C. or higher and 750° C. or lower. The high oxygen atmosphere refers to an atmosphere in which 50 vol % or more of oxygen is contained. Firing in the high oxygen atmosphere can promote the generation of trivalent nickel and suppress a case where divalent nickel is mixed into the 3a configuration. In addition, firing at 650° C. or higher can make the inside of the precursor particles fired, and can promote the formation of the layered rock salt structure. On the other hand, firing at 750° C. or lower can suppress a case where an inert structure is generated when lithium is volatilized during firing, and can improve the electrochemical characteristics of LNO.

Next, as a water washing step, LNO is washed with water (step S40). LNO is washed with water by adding water to the primary-fired product and stirring the mixture. When LNO is washed with water, a larger amount of residual lithium can be removed under the conditions of higher temperature, lower solid content, and longer stirring time. LNO is preferably washed with water in pure water at 10° C. or more and 40° C. or less, in a state of a solid content of 30 vol % or more and 80 vol % or less, and under stirring for 3 minutes or more and 10 minutes or less. Under the water-washing conditions, it is possible to suppress a case where lithium on the surface of LNO is insufficiently removed to reduce capacity retention rate, and it is possible to suppress a case where lithium on the surface of LNO is excessively removed to generate divalent nickel.

It is preferable to adjust the water-washing temperature, the water-washing solid content, and the stirring time according to the particle size distribution of the LNO particles. For example, the LNO particles having a median diameter of 15 μm in the primary-fired product are preferably washed with pure water at a water-washing temperature of 25° C., in a solid content of 50 vol %, and for a stirring time of 7 minutes. Thus, it is possible to suppress a case where lithium on the surface of LNO is insufficiently removed to reduce capacity retention rate, and it is possible to suppress a case where lithium on the surface of LNO is excessively removed to generate divalent nickel.

Next, as a drying step, water in the washed LNO is removed (step S50). Here, the moisture content in LNO is preferably 350 ppm or less after the drying step. Thereby, it is possible to suppress a case where the positive electrode material is deteriorated in slurry property and divalent nickel is generated.

Next, as a coating step, the surface of the dried LNO particles is coated with a coating agent (step S60). Thereby, direct contact with the electrolytic solution can be prevented, and surface deterioration of the positive electrode active material and rapid heat release during overcharge or the like can be prevented. The coating agent preferably contains at least one element of aluminum, cerium (Ce), boron (B), phosphorus (P), zirconium, niobium (Nb), titanium, magnesium, fluorine (F), and sulfur(S). The coating agent preferably contains no element that generates ions having a valency of 4 or more and forms a solid solution with LNO. Thereby, it is possible to suppress a case where the coating agent reduces trivalent nickel on the surface of LNO to divalent nickel.

Preferably, the coating agent is sufficiently dried, and does not have moisture adhering thereto. As a result, it is possible to suppress a case where the coating agent for LNO is in contact with moisture, and it is possible to suppress a case where the water content in LNO is increased.

Next, as a secondary firing step, the coated LNO particles are fired (step S70). The secondary firing is performed in a high oxygen atmosphere at a firing temperature of 500° C. or more and 650° C. or less for a firing time of 5 hours or more and 12 hours or less. When the secondary firing temperature is 500° C. or higher, oxidation of divalent nickel to trivalent nickel can be promoted. On the other hand, when the secondary firing temperature is 650° C. or lower, it is possible to suppress a case where moisture remaining in LNO replaces lithium in LNO, and it is possible to suppress a case where residual lithium and divalent nickel are generated. Thereby, the coating agent can be promoted to diffuse on the surface of LNO to uniformly coat the LNO, and divalent nickel on the surface of LNO generated in the previous steps can be oxidized to trivalent nickel.

In addition, the firing temperature and the firing time of the secondary firing are preferably adjusted according to the particle size distribution of the LNO particles. For example, particles in which LNO particles having a median diameter of 15 μm are coated with the coating agent are preferably subjected to the secondary firing at 640° C. for 10 hours. Thereby, the amount of divalent nickel can be more suitably adjusted.

Although an example of the synthesis method of LNO according to an embodiment has been described above, the synthesis method is not limited thereto, and can be appropriately modified.

For example, the 3b-configured metal other than nickel and cobalt, such as aluminum, is not only added as a hydroxide in the precursor-preparation step, and may be added as a salt such as aluminum sulfate (Al₂(SO₄)₃) to the aqueous solution of a metal salt in the coprecipitation step. In this case, a mixture containing a hydroxide of other 3b-configured metals such as aluminum hydroxide (Al(OH)₃) in addition to nickel hydroxide and cobalt hydroxide can be obtained by a coprecipitation method.

In the coprecipitation step, a buffer such as ammonium sulfate ((NH₄)₂SO₄) may be further added to the aqueous solution of a 3b-configured metal salt. In this case, since pH increase due to the addition of the base can be suppressed, the precipitation rate is slow in the mixture of 3b-configured metal hydroxides, and the yield is improved.

In the coprecipitation step, an aqueous ammonia (NH₃) solution as a complexing agent may be added to the aqueous solution of a 3b-configured metal salt. In this case, when the base is added to the aqueous solution of a 3b-configured metal salt, an aqueous ammonia (NH₃) solution may be further added in order to adjust the concentration of ammonium ions (NH⁴⁺).

As described above, the positive electrode active material according to an embodiment is a positive electrode active material including: a lithium nickel composite oxide, wherein the lithium nickel composite oxide has a composition formula represented by LiₐNiₓCo_{y}Al_{1-x-y}O₂, x is 0.8 or more and 1 or less, y is 0 or more and 0.2 or less, and a is 0.8 or more and 1.05 or less. Lithium hydroxide and lithium carbonate are contained in a supernatant of a stirred product of the positive electrode active material and pure water in a total amount of 1.0 mass % or less with respect to the positive electrode active material, when measured by a potentiometric titration method. In the positive electrode active material, an intensity ratio of a peak top in 850 eV or more and 854 eV or less to a peak top in 854 eV or more and 860 eV or less is 1.05 or more and 1.45 or less in an X-ray absorption fine structure (XAFS) spectrum for an L-absorption edge of nickel. As a result, since generation of both residual lithium and divalent nickel ions is suppressed, an increase in the charge transfer resistance of the positive electrode and a decrease in capacity retention rate can be suppressed.

As a desirable embodiment, in the positive electrode active material, x is 0.87 or more and 1 or less, and y is 0 or more and 0.11 or less. As a result, the charge/discharge capacity against charge voltage can be further increased, and the use of expensive cobalt can be further suppressed.

As a more desirable embodiment, 1 kg of the positive electrode active material contains 0 mg or more and 350 mg or less of water in mass. This makes it possible to suppress thickening of the positive electrode slurry.

The secondary battery 1 according to an embodiment is a secondary battery including: a positive electrode 210; and a negative electrode 220, wherein the positive electrode 210 contains a positive electrode material containing a lithium nickel composite oxide as a positive electrode active material, the lithium nickel composite oxide has a composition formula represented by LiₐNiₓCo_{y}Al_{1-x-y}O₂, x is 0.8 or more and 1 or less, y is 0 or more and 0.2 or less, and a is 0.8 or more and 1.05 or less. Lithium hydroxide and lithium carbonate are contained in a supernatant of a stirred product of the positive electrode material in state of charge (SoC) of 0% and pure water in a total amount of 1.0 mass % or less with respect to the positive electrode active material, when measured by a potentiometric titration method. In the positive electrode in SoC of 0%, an intensity ratio of a peak top in 850 eV or more and 854 eV or less to a peak top in 854 eV or more and 860 eV or less is 1.05 or more and 1.45 or less in an X-ray absorption fine structure (XAFS) spectrum for an L-absorption edge of nickel. As a result, it is possible to suppress an increase in the charge transfer resistance of the positive electrode 210 and a decrease in capacity retention rate due to charging and discharging of the secondary battery 1.

In an embodiment, in the secondary battery 1, x is 0.87 or more and 1 or less, and y is 0 or more and 0.11 or less. As a result, the charge/discharge capacity against charge voltage can be further increased, and the use of expensive cobalt can be further suppressed.

In an embodiment, in the secondary battery 1, 1 kg of the positive electrode active material contains 0 mg or more and 350 mg or less of water in mass. This makes it possible to suppress thickening of the positive electrode slurry.

### EXAMPLES

Hereinafter, Examples according to an embodiment will be described.

Table 2 shows measurement results of the positive electrode active materials of Examples and Comparative Examples. For the positive electrode active materials of Comparative Examples 1 and 2 and Examples 1 to 3, the amount of residual lithium and XAFS were measured.

TABLE 2

| | | | Capacity | Charge transfer | Charge transfer |
|---|---|---|---|---|---|
| | | | retention | resistance of | resistance of |
| | Residual | | rate at | positive | positive electrode |
| | lithium | XAFS peak | 100 | electrode before | after charge- |
| | amount | intensity | cycles | charge-discharge | discharge cycle |
| Example | (mass %) | ratio | (%) | cycle test (Ω) | test (Ω) |
| Example 1 | 0.46 | 1.18 | 86.0 | 2.8 | 115.1 |
| Comparative | 1.24 | 1.02 | 58.3 | 2.4 | 47.6 |
| Example 1 | | | | | |
| Comparative | 0.32 | 1.50 | 85.4 | 5.0 | 858.0 |
| Example 2 | | | | | |
| Example 2 | 0.35 | 1.45 | 86.1 | 3.1 | 125.9 |
| Example 3 | 0.51 | 1.05 | 81.2 | 2.6 | 90.5 |

### <<Measurement of Residual Lithium Amount>>

The amount of residual lithium in the synthesized positive electrode active material was measured by subjecting an aqueous solution in which the residual alkali content of the positive electrode active material was dissolved to neutralization titration by Warder's method. Specifically, in the neutralization titration, the amount of residual lithium was measured from the amount of acid titrated to the aqueous solution of residual alkali to the first neutralization point and the final (second) neutralization point. In the neutralization titration, measurement was performed by an electro-titration method, and the point showing the maximum change rate of the measured potential with respect to the acid-dropping amount was the final (second) neutralization point, and the point showing the second-maximum change rate of the potential was the first neutralization point. The aqueous solution of residual alkali to be used was obtained as follows: 10 g of the positive electrode active material was put in 50 ml of ultrapure water, stirred for 60 minutes, and allowed to stand for 60 minutes; after that, 10 ml of the aqueous solution was extracted, and diluted with 30 ml of ultrapure water. In the neutralization titration, hydrochloric acid having a concentration of 0.1 mol/L was used as the acid to be titrated to the aqueous solution of residual alkali. The amount of residual lithium was calculated by the formula (4).

### <<XAFS Measurement>>

The XAFS peak intensity ratio of the synthesized positive electrode active material was measured by XAFS for Ni L-edge. The measurement conditions of XAFS are as follows. The measurement time in one step and the interval per one step in the measurement energy region were performed under the conditions shown in Table 1. The obtained XAFS spectrum was calibrated by shifting the energy values using an energy calibration value. Here, the energy calibration value was the difference between the measurement value and the theoretical value of the photoelectron peak from Au 4f_{7/2} of gold foil as a standard sample.
Equipment used: Aichi SR BL1N2
Measurement method: Total electron yield method
Beam size: About 2 mm×1 mm
Diffraction grating frequency: 500 line/mm
Measurement energy region: 830 eV-920 eV

The calibrated XAFS spectrum was subjected to background removal and normalization. The calibrated XAFS spectrum was normalized using analysis software Athena so that the intensity of the pre-edge region on the lower energy side than the L₃-absorption edge of nickel is 0, and the intensity of the post-edge region on the higher energy side than the L-absorption edge of nickel is 1. Here, the pre-edge region on the lower energy side than the L₃-absorption edge of nickel refers to a region where the X-ray energy is 830.0 eV or more and 844.5 eV or less. The post-edge region on the higher energy side than the L-absorption edge of nickel refers to a region where the X-ray energy is 863.0 eV or more and 918.0 eV or less. The peak appearing in the energy region of 850 eV or more and 860 eV or less in the XAFS spectrum subjected to background removal and normalization was specified as the Ni L₃-absorption edge, and the XAFS peak intensity ratio was calculated.

### <<Production of Coin Cell>>

Coin cells were produced from the positive electrodes produced from the positive electrode active materials of Comparative Examples 1 and 2 and Examples 1 to 3. Here, the positive electrode of the coin cell was prepared by mixing 95.5 mass % of the positive electrode active material, 1.7 mass % of carbon black as a conductive agent, 1.9 mass % of polyvinylidene fluoride as a binder, and 0.1 mass % of polyvinylpyrrolidone as a dispersant with respect to the total mass of the positive electrode, forming a sheet, and punching the sheet into a disk shape having a diameter of 16.5 mm. The positive electrode processed into a disk shape, a polyethylene separator having a diameter of 17.5 mm as the separator, and metal lithium having a diameter of 17 mm as the negative electrode were superposed with each other, and an electrolytic solution was added thereto. Thereby, a coin cell was produced. Here, the electrolytic solution to be used was obtained as follows: a 1.2 mol/L LiPF₆ solution whose solvent was a mixture of carbonate ester and diethyl carbonate in a volume ratio of 3:7 is added with fluoroethylene carbonate in an amount of 10 mass % with respect to the solution. The produced coin cell was allowed to stand for 10 hours, the coin cell was sufficiently impregnated with the electrolytic solution, and then a charge-discharge cycle test and charge transfer resistance measurement were performed.

### <<Charge-Discharge Cycle Test>>

The assembled coin cell was subjected to a charge-discharge cycle test, and capacity retention rate at 100 cycles was calculated. The charge-discharge cycle test was performed under an environment of 60° C., and the capacity retention rate at 100 cycles was defined as the discharge capacity at 100 cycles with respect to the discharge capacity at 1 cycle. In the charge-discharge cycle test, CCCV charge was performed in charge process, and CC discharge was performed in discharge process under the following conditions. More specifically, in the charge process, charging was performed at a constant charging rate; after reaching the charge control voltage, charging was performed at the charge control voltage; and charging was terminated when the current value decreased to the charge cutoff current. In the discharge process, discharging was performed at a constant discharging rate; and discharging was terminated when the voltage reached the discharge-termination voltage.
Charging rate: 1C
Charge control voltage: 4.25 V
Charge cutoff current: 0.065 mA
Discharging rate: 5C
Discharge-termination voltage: 2.5 V

### <<Measurement of Charge Transfer Resistance>>

For the coin cell before the charge-discharge cycle test and the coin cell after the charge-discharge cycle test, the charge transfer resistance of the positive electrode was measured by electrochemical impedance spectroscopy (EIS). EIS was measured under the following conditions to obtain a Nyquist diagram. The length of the real axis (Z_{Re}) of the arc on the low frequency side in the obtained Nyquist diagram was calculated as the charge transfer resistance of the positive electrode.
Applied voltage: 10 mV
Measurement frequency: 100 kHz-0.1 Hz
Measurement temperature: 25° C.
Measurement voltage: 4.25 V

### Example 1

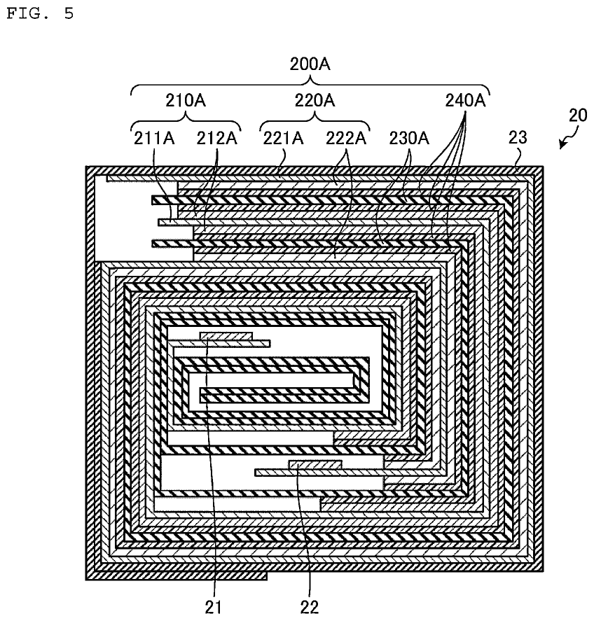

FIG. 7 is a chart showing results of XAFS measurement according to Example 1. In the positive electrode active material according to Example 1, the amount of residual lithium is 0.46 mass %, and the XAFS peak intensity ratio is 1.18 as shown in FIG. 7.

The positive electrode active material according to Example 1 was prepared by the following method.

In the coprecipitation step, first, an aqueous solution of ammonia (NH₃) as a complexing agent and an aqueous solution of ammonium sulfate ((NH₄)₂SO₄) as a buffering agent were prepared and charged into a reaction vessel equipped with a stirrer. Into the reaction vessel, an aqueous solution of nickel sulfate (NiSO₄) and cobalt sulfate (CoSO₄), an aqueous solution of sodium hydroxide (NaOH) as a pH adjusting agent, and an aqueous ammonia solution were simultaneously charged. Here, the aqueous solution of nickel sulfate and cobalt sulfate was prepared so that the molar ratio of nickel and cobalt was 9:1. The aqueous solution of sodium hydroxide was added so that the aqueous solution in the reaction vessel had a pH of 10.5. These solutions were stirred in the reaction vessel, the precipitated particles were grown and filtered, and the precipitate was washed with pure water and then dried. Thus, a secondary particulate nickel cobalt composite hydroxide was obtained.

In the precursor-preparation step, the nickel cobalt composite hydroxide, lithium hydroxide monohydrate (LiOH·H₂O), and aluminum hydroxide (Al(OH)₃) were mixed to prepare a precursor. The mixing amount of lithium hydroxide monohydrate (LiOH·H₂O) and aluminum hydroxide (Al(OH)₃) was adjusted so that the molar ratio of lithium in the precursor was 1.03 with respect to the total amount of nickel, cobalt, and aluminum.

In the primary firing step, the mixture was subjected to primary firing in a high oxygen atmosphere at a firing temperature of 730° C. for a firing time of 12 hours. Through the primary firing, a lithium nickel composite oxide (LNO) LiNi_{0.89}CO_{0.09}Al_{0.02}O₂ was obtained.

In the water washing step, 50 g of LNO was added to 50 g of pure water. The solution was stirred at a solution temperature of 25° C. for 7 minutes and the LNO was recovered with a suction filter.

In the drying step, the LNO was vacuum-dried in a vacuum dryer at a drying temperature of 250° C. for 6 hours.

In the coating step, aluminum oxide (Al₂O₃) was added and mixed in an amount of 0.25 mass % with respect to the LNO in an environment where the dew point was −60° C. Thus the LNO coated with aluminum oxide was obtained.

In the secondary firing step, the LNO coated with aluminum oxide was subjected to secondary firing in a high oxygen atmosphere at a firing temperature of 640° C. for a firing time of 10 hours.

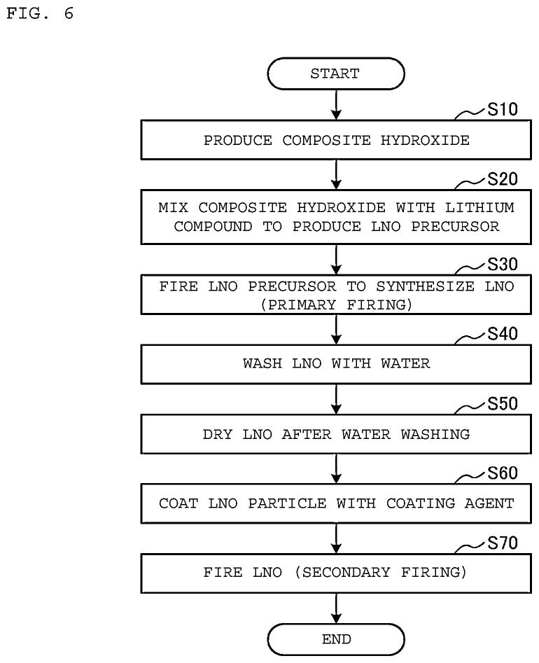

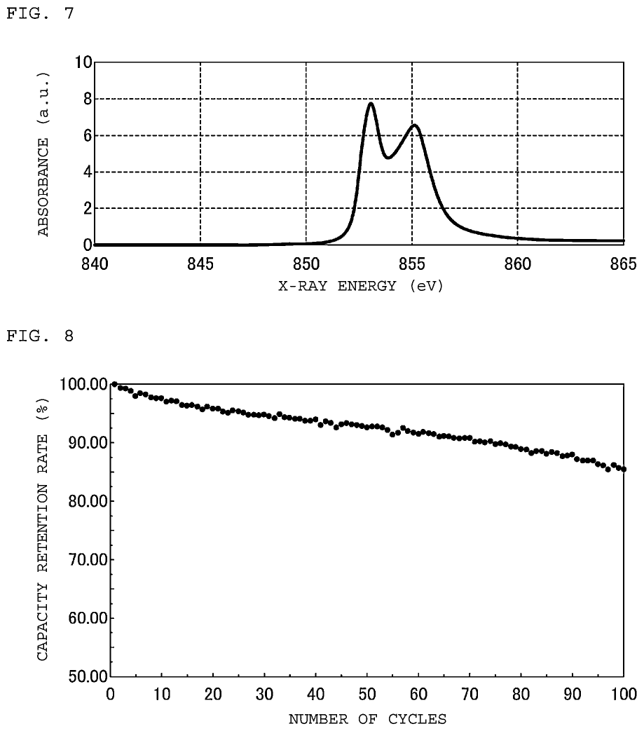

FIG. 8 is a chart showing the capacity retention rate of the coin cell according to Example 1. FIG. 9 is a Nyquist diagram of the coin cell according to Example 1 before a charge-discharge cycle test. FIG. 10 is a Nyquist diagram of the coin cell according to Example 1 after a charge-discharge cycle test. As shown in FIG. 8, the capacity retention rate at 100 cycles of the coin cell produced from the positive electrode active material of Example 1 was 86.0%. The charge transfer resistance of the positive electrode before the charge-discharge cycle test determined from FIG. 9 was 2.8Ω. On the other hand, the charge transfer resistance of the positive electrode after the charge-discharge cycle test determined from FIG. 10 was 115.1Ω.

It is found that, since the positive electrode active material according to Example 1 has been subjected to an appropriate water washing treatment, the amount of residual lithium is small, and the capacity retention rate is high and the XAFS peak intensity ratio is small. As a result, an increase in charge transfer resistance and a decrease in capacity retention rate are suppressed after the charge-discharge cycle test.

### Comparative Example 1

FIG. 11 is a chart showing results of XAFS measurement according to Comparative Example 1. In the positive electrode active material according to Comparative Example 1, the amount of residual lithium is 1.24 mass %, and the XAFS peak intensity ratio is 1.02 as shown in FIG. 11.

The production method of the positive electrode active material according to Comparative Example 1 is different from that of Example 1 in that the stirring time in the water washing step was 1 minute, the drying step was performed at a drying temperature of 100° C. for 2 hours, and firing was performed at 660° C. in the secondary firing step.

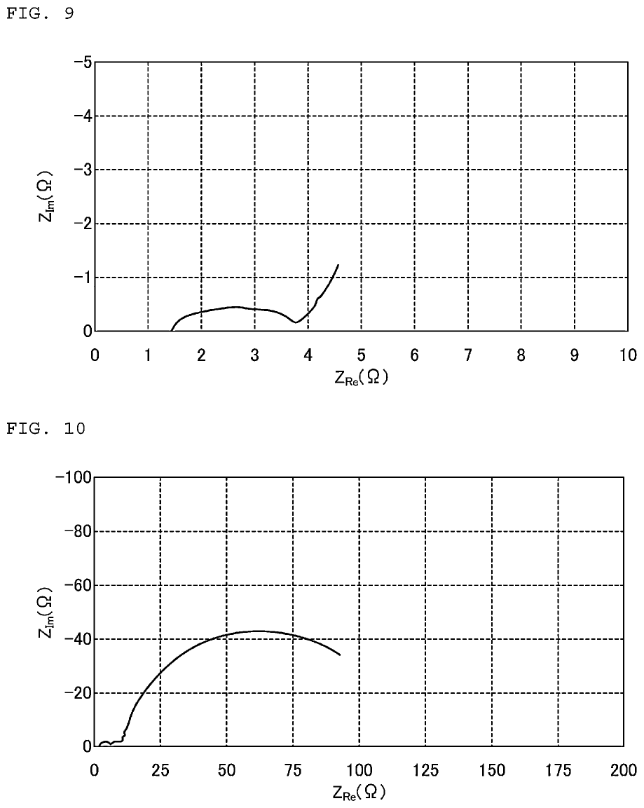

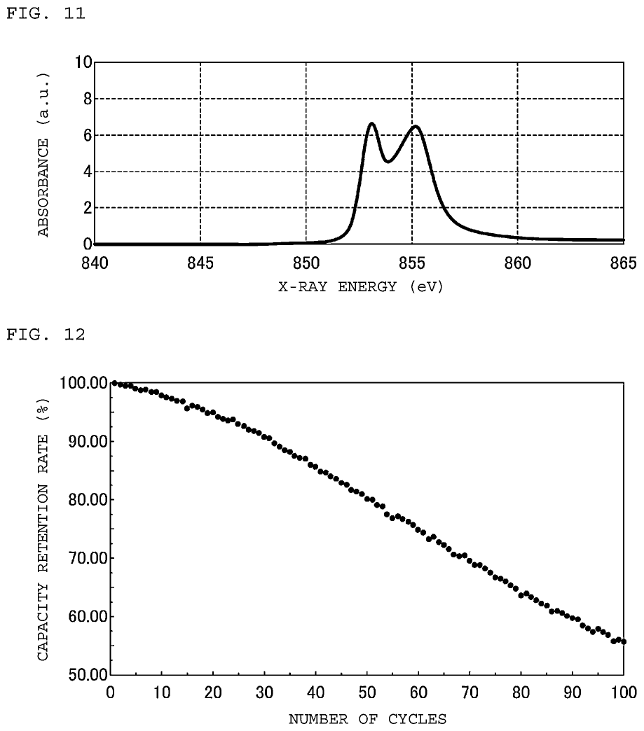

FIG. 12 is a chart showing the capacity retention rate of the coin cell according to Comparative Example 1. FIG. 13 is a Nyquist diagram of the coin cell according to Comparative Example 1 before a charge-discharge cycle test. FIG. 14 is a Nyquist diagram of the coin cell according to Comparative Example 1 after a charge-discharge cycle test.

As shown in FIG. 12, the capacity retention rate of the coin cell produced from the positive electrode active material of Example 1 was 58.3%. The charge transfer resistance of the positive electrode before the charge-discharge cycle test determined from FIG. 13 was 2.4Ω. On the other hand, the charge transfer resistance of the positive electrode after the charge-discharge cycle test determined from FIG. 14 was 47.6Ω.

The positive electrode active material according to Comparative Example 1 was subjected to the secondary firing at a high temperature in a state where water washing was performed in a short time in the water washing step, drying was performed in a short time after water washing, and a large amount of moisture adhered to LNO. Therefore, the amount of residual lithium increased. As a result, the capacity retention rate was decreased. However, since water washing was performed in a short time, generation of divalent nickel was suppressed, and the value of the XAFS peak intensity ratio was low. Therefore, an increase in charge transfer resistance after the charge-discharge cycle test is suppressed.

### Comparative Example 2

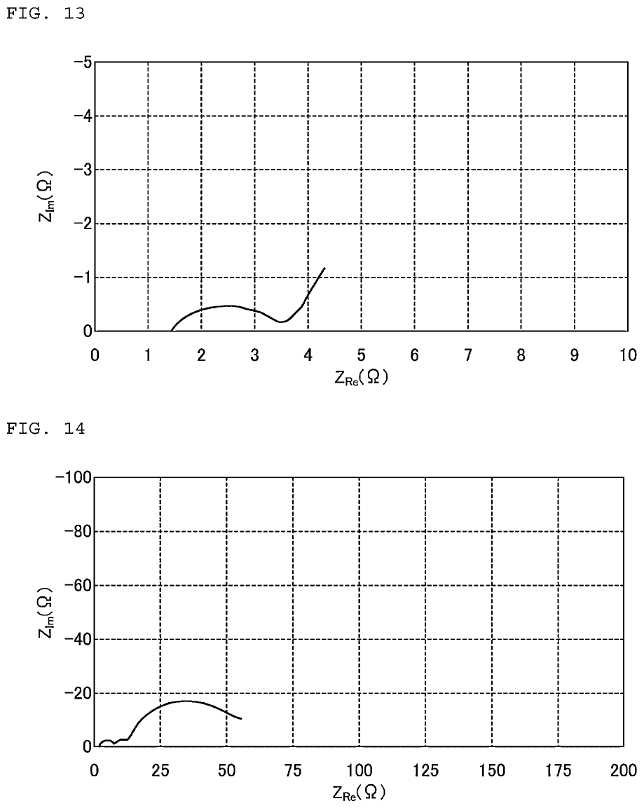

FIG. 15 is a chart showing results of XAFS measurement according to Comparative Example 2. In the positive electrode active material according to Comparative Example 2, the amount of residual lithium is 0.32 mass %, and the XAFS peak intensity ratio is 1.50 as shown in FIG. 15.

The method for producing a positive electrode active material according to Comparative Example 2 is different from that of Example 1 in that 20 g of LNO was added to 80 g of pure water in the water washing step, and the stirring time was changed to 15 minutes.

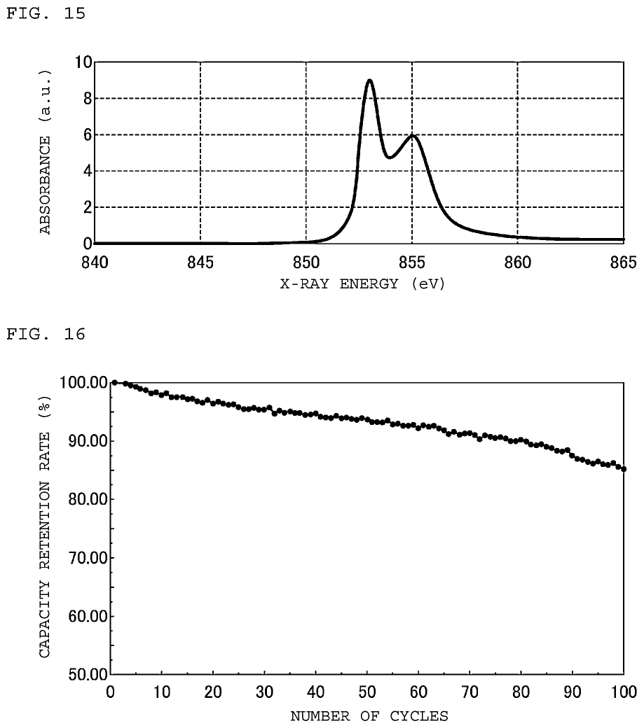

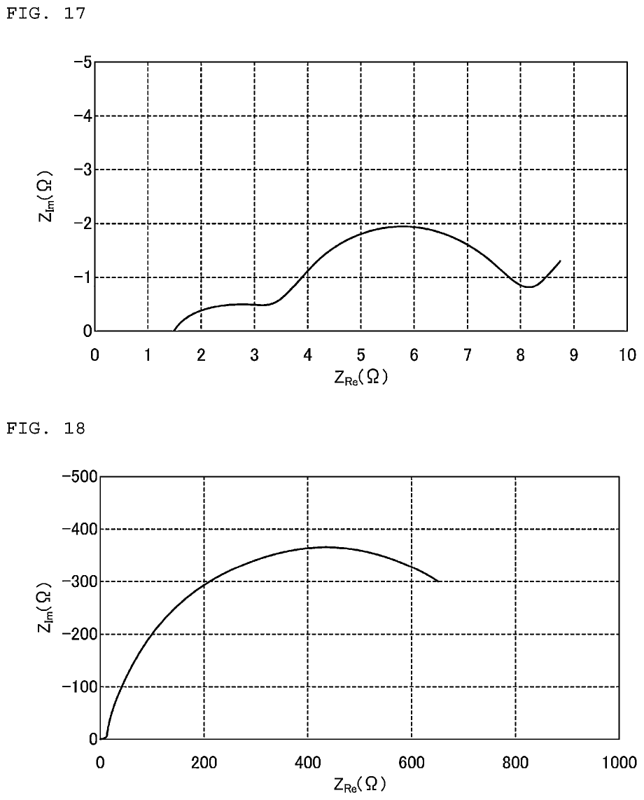

FIG. 16 is a chart showing the capacity retention rate of the coin cell according to Comparative Example 2. FIG. 17 is a Nyquist diagram of the coin cell according to Comparative Example 2 before a charge-discharge cycle test. FIG. 18 is a Nyquist diagram of the coin cell according to Comparative Example 2 after a charge-discharge cycle test. As shown in FIG. 16, the capacity retention rate at 100 cycles of the coin cell produced from the positive electrode active material of Example 1 was 85.4%. As shown in FIG. 17, the charge transfer resistance of the positive electrode before the charge-discharge cycle test was 5.0Ω. On the other hand, as shown in FIG. 18, the charge transfer resistance of the positive electrode after the charge-discharge cycle test was 858.0Ω.

The positive electrode active material according to Comparative Example 2 has been washed with water in high strength and has residual lithium in a small amount. Therefore, a decrease in the capacity retention rate is suppressed. On the other hand, since the lithium ions in the 3a configuration were replaced with hydrogen ions during water washing, the XAFS peak intensity ratio increased. As a result, the charge transfer resistance after the charge-discharge cycle test increases.

### Example 2

FIG. 19 is a chart showing results of XAFS measurement according to Example 2. In the positive electrode active material according to Example 2, the amount of residual lithium is 0.35 mass %, and the XAFS peak intensity ratio is 1.45 as shown in FIG. 19.

In the method for producing a positive electrode active material according to Example 2, 50 g of LNO was added to 50 g of pure water in the water washing step. The solution was stirred at a water temperature of 25° C. for 10 minutes for washing, and the addition amount of aluminum oxide was 0.10 mass % in the coating step, which is different from Example 1.

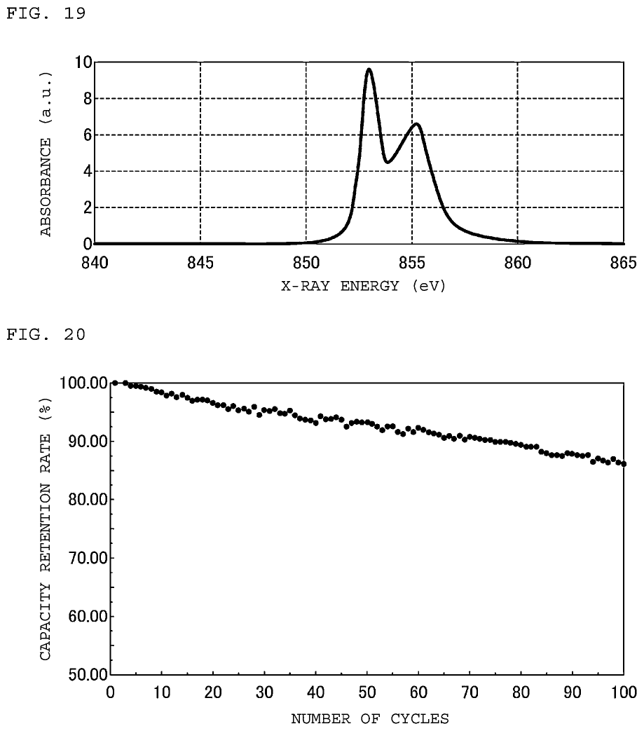

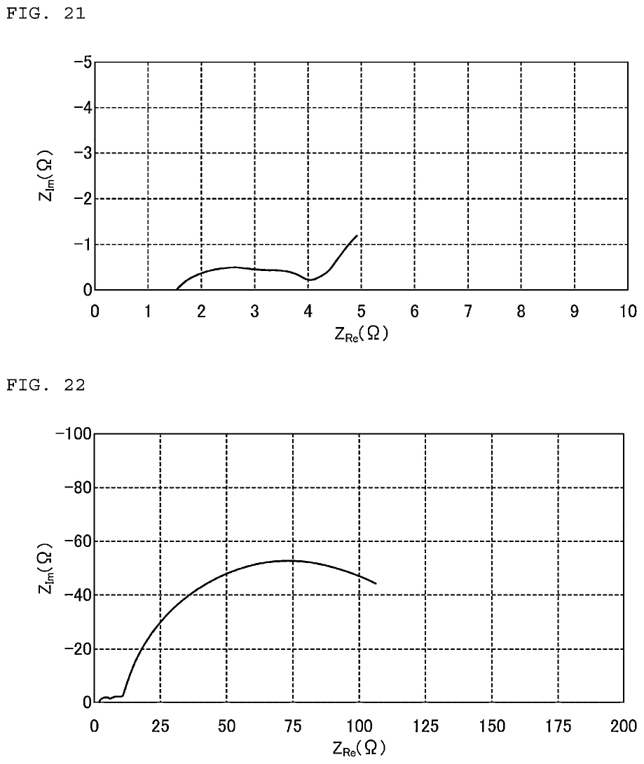

FIG. 20 is a chart showing the capacity retention rate of the coin cell according to Example 2. FIG. 21 is a Nyquist diagram of the coin cell according to Example 2 before a charge-discharge cycle test. FIG. 22 is a Nyquist diagram of the coin cell according to Comparative Example 1 after a charge-discharge cycle test. As shown in FIG. 20, the capacity retention rate at 100 cycles of the coin cell produced from the positive electrode active material of Example 1 was 86.1%. As shown in FIG. 21, the charge transfer resistance of the positive electrode before the charge-discharge cycle test was 3.1Ω. On the other hand, as shown in FIG. 22, the charge transfer resistance of the positive electrode after the charge-discharge cycle test was 125.9Ω.

The positive electrode active material according to Example 2 has been washed with water in slightly higher strength than that of Example 1, and therefore, has residual lithium in a small amount and has an increased XAFS peak intensity ratio.

### Example 3

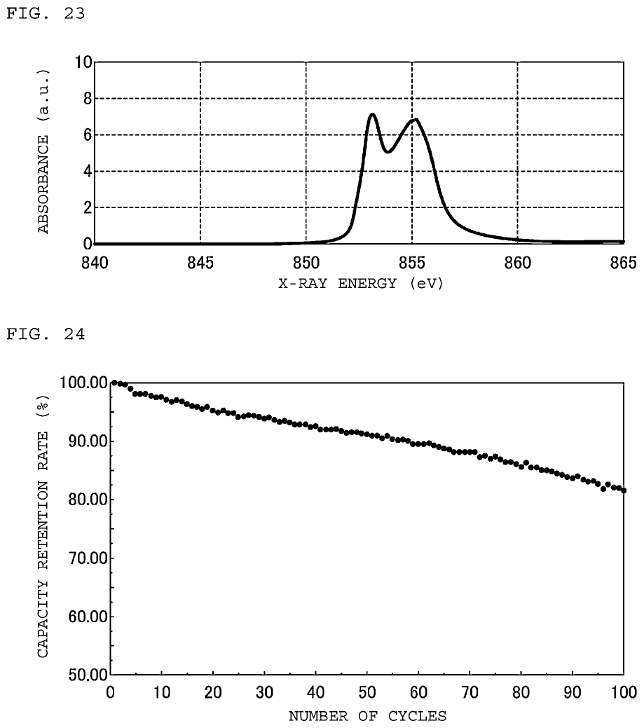

FIG. 23 is a chart showing results of XAFS measurement according to Example 3. In the positive electrode active material according to Example 3, the amount of residual lithium is 0.51 mass %, and the XAFS peak intensity ratio is 1.05 as shown in FIG. 23.

The method for producing a positive electrode active material according to Example 3 is different from that of Example 1 in that the stirring time was 5 minutes in the water washing step.

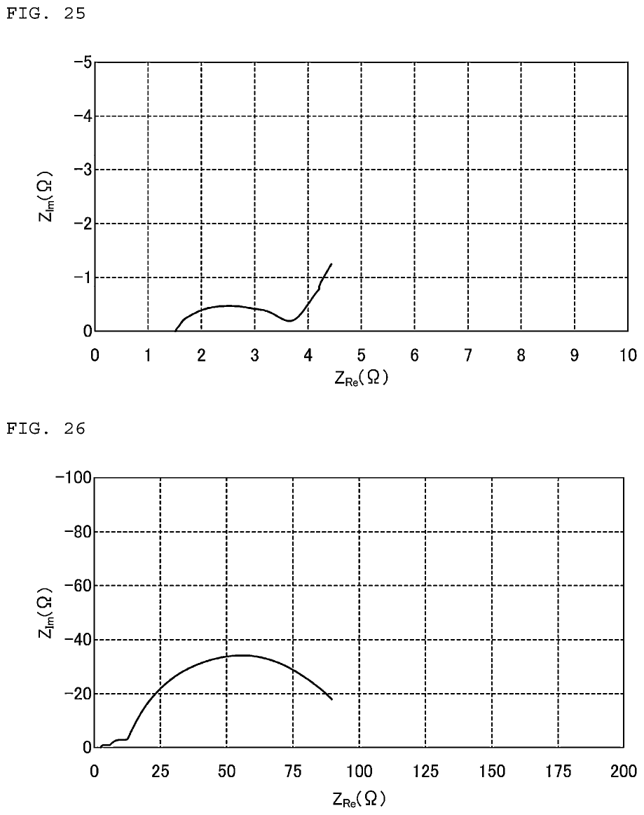

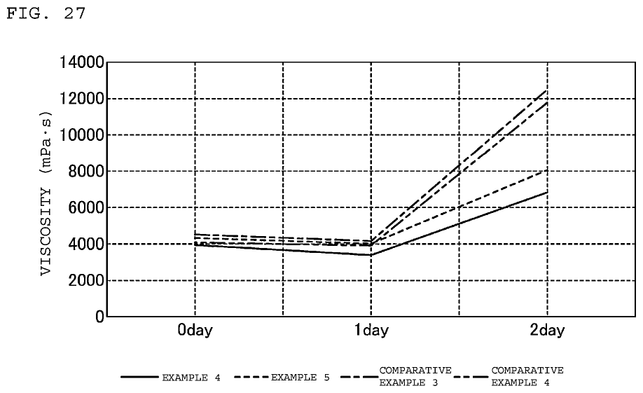

FIG. 24 is a chart showing the capacity retention rate of the coin cell according to Example 3. FIG. 25 is a Nyquist diagram of the coin cell according to Example 3 before a charge-discharge cycle test. As shown in FIG. 24, the capacity retention rate at 100 cycles of the coin cell produced from the positive electrode active material of Example 1 was 81.2%. FIG. 25 is a Nyquist diagram of the coin cell according to Comparative Example 1 after a charge-discharge cycle test. As shown in FIG. 24, the charge transfer resistance of the positive electrode before the charge-discharge cycle test was 2.6Ω. On the other hand, as shown in FIG. 25, the charge transfer resistance of the positive electrode after the charge-discharge cycle test was 90.5Ω.

The positive electrode active material according to Example 3 has been washed with water in slightly lower strength than that of Example 1, and therefore, has residual lithium in a large amount and has a reduced XAFS peak intensity ratio.

### Examples 4 and 5 and Comparative Examples 3 and 4

Table 3 shows the amount of residual lithium and the water content in the positive electrode active materials of Examples 4 and 5 and Comparative Examples 3 and 4. The positive electrode active materials of Examples 4 and 5 and Comparative Examples 3 and 4 had the residual lithium amount and the water content shown in Table 3, by adjusting the conditions in the water washing step and the drying step of the positive electrode active material of Example 1, respectively. To measure the water content, the positive electrode active material was subjected to a coulometric titration method using a Karl Fischer moisture meter.

TABLE 3

| | | Water content per 1 kg |
|---|---|---|
| | Residual | of positive electrode |
| | lithium amount | active material |
| Example | (mass %) | (mg) |
| Example 4 | 0.46 | 170 |
| Example 5 | 0.34 | 350 |
| Comparative | 0.32 | 530 |
| Example 3 | | |
| Comparative | 0.49 | 410 |
| Example 4 | | |

Positive electrode slurries containing the positive electrode active materials of Comparative Examples 3 and 4 and Examples 4 and 5 shown in Table 3 were prepared, and the viscosity of each of the positive electrode slurries was measured. Here, the positive electrode slurry was prepared by mixing 95.5 mass % of the positive electrode active material, 1.7 mass % of carbon black as a conductive agent, 1.9 mass % of polyvinylidene fluoride as a binder, and 0.1 mass % of polyvinylpyrrolidone as a dispersant with respect to the total amount of the solid content of the positive electrode, and adding N-methylpyrrolidone as a solvent so that the solid content was 75 mass %. The prepared positive electrode slurry was left standing in the air at 60° C. for predetermined days (0 day, 1 day, or 2 days) and then stirred, and the viscosity thereof was measured with a B-type viscometer under the following conditions.
Rotor rotation speed: 30 rpm
Measurement time: 30 seconds

FIG. 27 is a graph showing the measurement results of the time course of the viscosity of positive electrode slurries using the positive electrode active materials in Examples 4 and 5 and Comparative Examples 3 and 4. As shown in FIG. 27, it is found that, in Comparative Examples 3 and 4, in which the water content per 1 kg of the positive electrode active material is more than 0.0350 mass %, the viscosity of the positive electrode slurry significantly increases on the second day. On the other hand, it is found that, in Examples 4 and 5, in which the water content per 1 kg of the positive electrode active material is 0.0350 mass % or less, an increase in the viscosity of the positive electrode slurry is suppressed.

Note that an embodiments described above are intended to facilitate understanding of the present disclosure, but not intended to construe the present disclosure in any limited way. The present disclosure may be modified/improved without departing from the spirit thereof, and the present disclosure includes equivalents thereof.

### DESCRIPTION OF REFERENCE SYMBOLS

1, 1A: Secondary battery
10: Casing
11: Battery can
12: Lid
13: Heat sensitive resistance element
14: Safety valve mechanism
15: Gasket
16: Positive electrode lead
17: Negative electrode lead
18: Insulating plate
19: Center pin
20: Battery element
21: Positive electrode lead
22: Negative electrode lead
23: Protective member
31: Exterior member
32: Adhesive member
200, 200A: Electrode assembly
210, 210A: Positive electrode
211, 211A: Positive electrode current collector layer
212, 212A: Positive electrode material layer
220, 220A: Negative electrode
221, 221A: Negative electrode current collector layer
222, 222A: Negative electrode material layer
230, 230A: Separator
240A: Electrolyte layer

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A positive electrode active material comprising: a lithium nickel composite oxide, wherein
the lithium nickel composite oxide has a composition formula represented by LiₐNiₓCo_{y}Al_{1-x-y}O₂, x is 0.8 or more and 1 or less, y is 0 or more and 0.2 or less, and a is 0.8 or more and 1.05 or less;
lithium hydroxide and lithium carbonate are contained in a supernatant of a stirred product of the positive electrode active material and pure water in a total amount of 1.0 mass % or less with respect to the positive electrode active material, when measured by a potentiometric titration method; and
in the positive electrode active material, an intensity ratio of a peak top in 850 eV or more and 854 eV or less to a peak top in 854 eV or more and 860 eV or less is 1.05 or more and 1.45 or less in an X-ray absorption fine structure (XAFS) spectrum for an L-absorption edge of nickel.

2. The positive electrode active material according to claim 1, wherein the x is 0.87 or more and 1 or less, and the y is 0 or more and 0.11 or less.

3. The positive electrode active material according to claim 1, wherein 1 kg of the positive electrode active material contains 0 mg or more and 350 mg or less of water in mass.

4. The positive electrode active material according to claim 1, further including a coating agent provided on the lithium nickel oxide composite, wherein the coating agent includes no element that generates ions having a valency of 4 or more and forms a solid solution with the lithium nickel oxide composite.

5. A secondary battery comprising: a positive electrode; and a negative electrode, wherein
the positive electrode contains a positive electrode material containing a lithium nickel composite oxide as a positive electrode active material;
the lithium nickel composite oxide has a composition formula represented by LiₐNiₓCo_{y}Al_{1-x-y}O₂, x is 0.8 or more and 1 or less, y is 0 or more and 0.2 or less, and a is 0.8 or more and 1.05 or less;
lithium hydroxide and lithium carbonate are contained in a supernatant of a stirred product of the positive electrode material in state of charge (SoC) of 0% and pure water in a total amount of 1.0 mass % or less with respect to the positive electrode active material, when measured by a potentiometric titration method; and
in the positive electrode in SoC of 0%, an intensity ratio of a peak top in 850 eV or more and 854 eV or less to a peak top in 854 eV or more and 860 eV or less is 1.05 or more and 1.45 or less in an X-ray absorption fine structure (XAFS) spectrum for an L-absorption edge of nickel.

6. The secondary battery according to claim 5, wherein the x is 0.87 or more and 1 or less, and the y is 0 or more and 0.11 or less.

7. The secondary battery according to claim 5, wherein 1 kg of the positive electrode active material contains 0 mg or more and 350 mg or less of water in mass.

8. The secondary battery according to claim 5, wherein the positive electrode active material including a coating agent provided on the lithium nickel oxide composite, and wherein the coating agent includes no element that generates ions having a valency of 4 or more and forms a solid solution with the lithium nickel oxide composite.
